(19) United States
(12) Patent Application Publication
(10) Pub. No.: US 2014/0211406 A1
(43) Pub. Date: Jul. 31, 2014

(54) STORAGE DEVICE AND MOTHERBOARD FOR SUPPORTING THE STORAGE DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: LEI LIU, Shenzhen (CN); GUO-YI CHEN, Shenzhen (CN)

(21) Appl. No.: 13/914,662

(22) Filed: Jun. 11, 2013

(30) Foreign Application Priority Data
Jan. 30, 2013 (CN) 2013100354336

(51) Int. Cl. G06F 1/18

(52) U.S. Cl. CPC G06F 1/185
USPC 361/679.32

(57) ABSTRACT

A motherboard assembly includes a motherboard and a storage device. The motherboard includes an expansion slot, a platform controller hub (PCH), a power circuit, a central processing unit (CPU), and a switch unit. The expansion slot includes a protrusion, hard disk drive (HDD) signal pins, memory signal pins, and power pins connected to the power circuit. An solid state storage unit, a random access memory (RAM) unit, and a power circuit connected to the solid state storage unit and the RAM unit are arranged on the storage device. A notch is defined in a bottom side of the storage device, to receive the protrusion. An edge connector is arranged on a bottom side of the storage device and includes HDD signal pins connected to the solid state storage unit, power pins connected to the power circuit, and memory signal pins connected to the RAM unit.

### BACKGROUND

1. Technical Field

The present disclosure relates to a motherboard for supporting a storage device.

2. Description of Related Art

Many computing devices provide large non-volatile storage capacities and large random access memory capacities. Depending on need, some users prefer computing devices having large non-volatile storage capacity, others prefer the computing devices having a large random access memory capacity. In general, a plurality of memory slots may be built into the motherboard of a computing device, to satisfy the requirements of users who want large random access memory capacities. However, for users who desire or prefer large non-volatile storage capacities, some of the memory slots may be unoccupied. These idle slots are useless for users not desiring large random access memory capacities, and thus these extra memory slots are essentially wasting real estate on the motherboard. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawing, like reference numerals designate corresponding parts throughout the several views.

FIG. 1 is an exploded, isometric view of a storage device and a motherboard for supporting the storage device in accordance with an embodiment of the present disclosure.

FIG. 2 is an assembled, isometric view of the storage device and the motherboard of FIG. 1.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

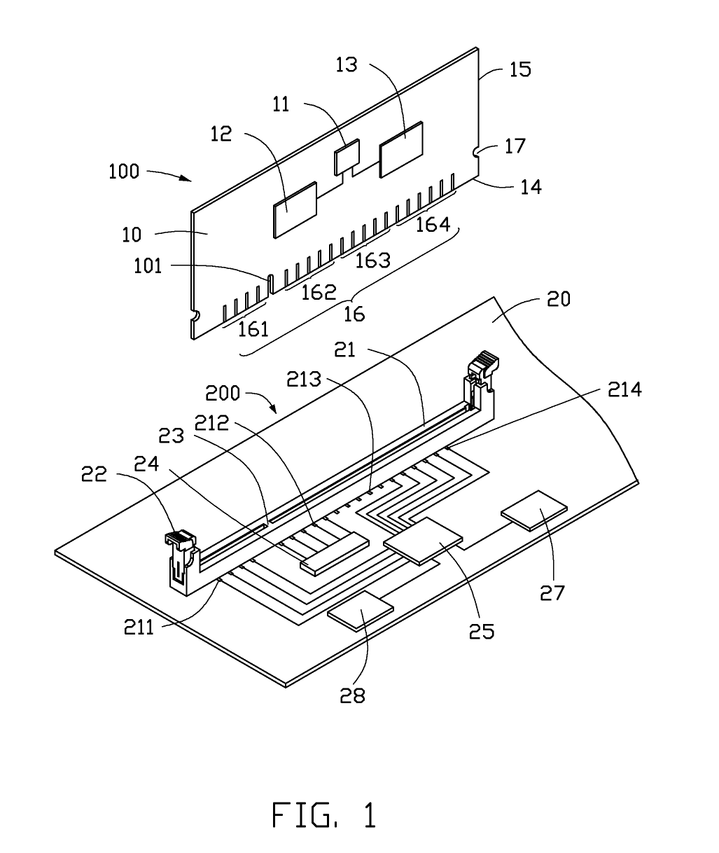

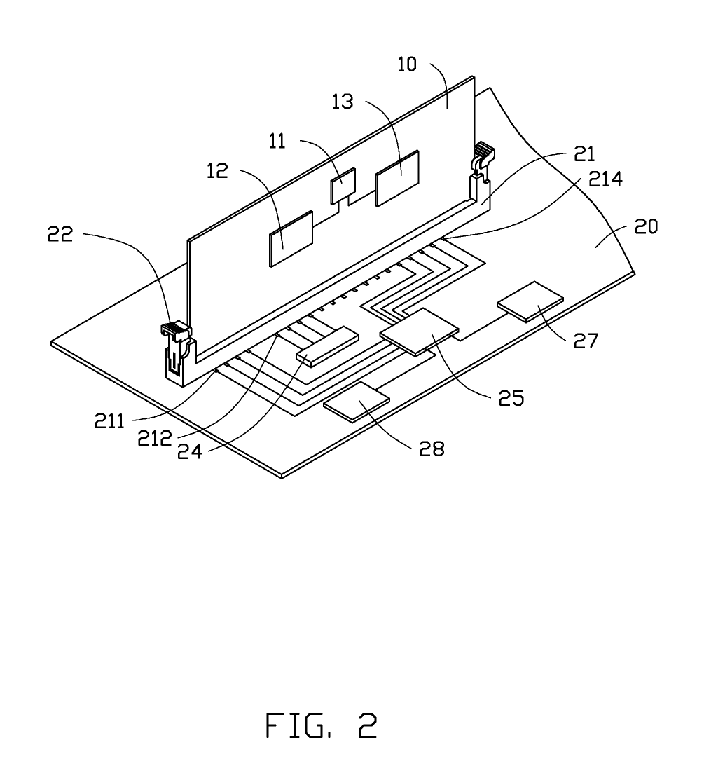

FIGS. 1 and 2 shows a storage device 100 in accordance with an embodiment. The storage device 100 includes a substantially rectangular circuit board 10. A power circuit 11, a solid state storage unit 12, and a random access memory (RAM) unit 13 are arranged on the circuit board 10. The power unit 11 is connected to the HDD storage device 12 and the RAM unit 13. An edge connector 16 is arranged on a bottom side 14 of the circuit board 10. The edge connector 16 includes four HDD signal pins 161, a plurality of power pins 162, a plurality of ground pins 163, and a plurality of memory signal pins 164. A notch 101 is defined in the bottom side 14 of the circuit board 10 and located between the HDD signal pins 161 and the power pins 162. The HDD signal pins 161 include a pair of signal input pins and a pair of signal output pins, and are connected to the solid state storage unit 12. The power pins 162 are connected to the power circuit 11. The memory signal pins 164 are connected to the RAM unit 13. The ground pins 163 are connected to a ground layer (not shown) of the circuit board 10. Two grooves 17 are arranged on two opposite ends 15 of the circuit board 10. In one embodiment, the HDD signal pins 161 transmit serial advanced technology attachment (SATA) signals, and the memory signal pins 164 transmit memory signals. The power circuit 11 converts a voltage from the edge connector 16 and provides the converted voltage to the solid state storage unit 12 and the RAM unit 13. The solid state storage unit 12 is the same as a general hard disk drive for storing data of a motherboard 200. The RAM unit 13 is the same as a general memory for storing data of the motherboard 200.

The motherboard 200 includes a circuit board 20. A platform controller hub (PCH) 28, a central processing unit (CPU) 27, a switch unit 25, an expansion slot 21, and a power circuit 24 are all arranged on the circuit board 20. In one embodiment, the expansion slot 21 is a memory slot. The switch unit 25 is a switch. Two fixing elements 22 are arranged on two ends of the expansion slot 21. The expansion slot 21 includes a protrusion 23 arranged in the expansion slot 21, four HDD signal pins 211, a plurality of power pins 212, a plurality of ground pins 213, and a plurality of memory signal pins 214. The power pins 212 are connected to the power circuit 24. The ground pins 213 are connected to a ground layer (not shown) of the circuit board 20. The HDD signal pins 211 and the memory signal pins 214 are connected to the switch unit 25. The switch unit 25 is connected to the PCH 28 and the CPU 27.

When the switch unit 25 is at a first state, the PCH 28 is connected to the expansion slot 21 through the switch unit 25 and the HDD signal pins 211. When the switch unit 25 is at a second state, the CPU 27 is connected to the expansion slot 21 through the switch unit 25 and the memory signal pins 214. When the switch unit 25 is at a third state, the PCH 28 is connected to the expansion slot 21 through the switch unit 25 and the HDD signal pins 211, and the CPU 27 is connected to the expansion slot 21 though the switch unit 25 and the memory signal pins 214.

In use, the edge connector 16 is inserted into the expansion slot 21, the protrusion 23 is engaged in the notch 101. The HDD signal pins 161, the power pins 162, the ground pins 163, and the memory signal pins 164 of the edge connector 16 are electrically connected to the HDD signal pins 211, the power pins 212, the ground pins 213, and the memory signal pins 214 of the expansion slot 21, respectively. The fixing elements 22 of the expansion slot 21 are engaged in the grooves 17 of the storage device 100, to fasten the storage device 100 to the expansion slot 21.

When the motherboard 200 receives power, the motherboard 200 outputs a voltage to the power circuit 11 through the power circuit 24, the power pins 212, and the power pins 162. The power circuit 11 converts the received voltage and provides the converted voltage to the solid state storage unit 12 and the RAM unit 13. At the same time, when the non-volatile storage capacity of the motherboard 200 needs to be expanded, the switch unit 25 is switched to the first state. The PCH 28 outputs an HDD signal, such as a SATA signal to the solid state storage unit 12 through the switch unit 25, and the HDD signal pins 211 and 161, to enable the PCH 28 to communicate with the storage device 100. When the random access memory capacity of the motherboard 200 needs to be expanded, the switch unit 25 is switched to the second state. The CPU 27 outputs a memory signal to the RAM unit 13 through the switch unit 25, and the memory signal pins 214 and 164, to enable the CPU 27 to communicate with the storage device 100. When the non-volatile storage capacity and the random access memory capacity of the motherboard 200 both need to be expanded, the switch unit 25 is switched to the third state. The PCH 28 outputs an HDD signal, such as a SATA signal to the solid state storage unit 12 through the switch unit 25, and the HDD signal pins 211 and 161, to enable the PCH 28 to communicate with the storage device 100, and at the same time, the CPU 27 outputs a memory signal to the RAM unit 13 through the switch unit 25, and the memory signal pins 214 and 164, to enable the CPU 27 to communicate with the storage device 100. Therefore, the storage capacity and/or the memory capacity of the motherboard 200 can be expanded.

Even though numerous characteristics and advantages of the disclosure have been set forth in the foregoing description, together with details of the structure and function of the disclosure, the disclosure is illustrative only, and changes may be made in detail, especially in matters of shape, size, and the arrangement of parts within the principles of the disclosure to the full extent indicated by the broad general meaning of the terms in which the appended claims are expressed.

What is claimed is:

1. A storage device comprising:
a circuit board;
a power circuit arranged on the circuit board, to receive a voltage and convert the received voltage;
a solid state storage unit arranged on the circuit board and connected to the power circuit, to receive the converted voltage from the power circuit;
a random access memory (RAM) unit arranged on the circuit board and connected to the power circuit, to receive the converted voltage from the power circuit; and
an edge connector and a notch arranged on a bottom side of the circuit board, to be inserted into an expansion slot of a motherboard, wherein the edge connector comprises four HDD signal pins connected to the solid state storage unit, a plurality of power pins connected to the power circuit, a plurality of ground pins, and a plurality of memory signal pins connected to the RAM unit.

2. The storage device of claim 1, wherein the HDD signal pins comprise a pair of signal input pins and a pair of signal output pins.

3. The storage device of claim 1, wherein two grooves are defined in two opposite ends of the circuit board.

4. The storage device of claim 1, wherein the HDD signal pins transmit serial advanced technology attachment (SATA) signals, and the plurality of memory signal pins transmits memory signals.

5. A motherboard for supporting a storage device, the motherboard comprising:
a circuit board;
a platform controller hub (PCH) mounted on the circuit board;
a central processing unit (CPU) mounted on the circuit board;
a switch unit mounted on the circuit board, and connected to the PCH and the CPU;
a power circuit mounted on the circuit board; and
an expansion slot mounted on the circuit board, and comprising a protrusion arranged in the expansion slot, four hard disk drive (HDD) signal pins connected to the switch unit, a plurality of power pins connected to the power circuit, a plurality of ground pins, and a plurality of memory signal pins connected to the switch unit;
wherein when non-volatile storage capacity of the motherboard needs to be expanded, the switch unit is switched to a first state, the PCH outputs an HDD signal through the switch unit and the HDD signal pins; when random access memory capacity of the motherboard needs to be expanded, the switch unit is switched to a second state, the CPU outputs a memory signal through the switch unit and the plurality of memory signal pins; when non-volatile storage capacity and random access memory capacity both need to be expanded, the switch unit is switched to a third state, the PCH outputs an HDD signal through the switch unit and the HDD signal pins, and the CPU outputs a memory signal through the switch unit and the plurality of memory signal pins.

6. The motherboard of claim 5, wherein the switch unit is a switch.

7. The motherboard of claim 5, wherein two fixing elements are arranged on two ends of the expansion slot.

8. The motherboard of claim 5, wherein the expansion slot is a memory slot.

9. A motherboard assembly comprising:
a motherboard comprising a first circuit board, an expansion slot mounted on the first circuit board, a platform controller hub (PCH) mounted on the first circuit board, a first power circuit mounted on the first circuit board, a central processing unit (CPU) mounted on the first circuit board, and a switch unit mounted on the first circuit board, the expansion slot comprising a protrusion, four first hard disk drive (HDD) signal pins electrically connected to the switch unit, a plurality of first power pins electrically connected to the first power circuit, a plurality of first ground pins, and a plurality of first memory signal pins connected to the switch unit; and
a storage device comprising a second circuit board, a second power circuit arranged on the second circuit board, an solid state storage unit arranged on the second circuit board and connected to the second power circuit, a random access memory (RAM) unit arranged on the second circuit board and connected to the second power circuit, and an edge connector and a notch set on a bottom side of the second circuit board to be detachably engaged in the expansion slot of the motherboard, the edge connector comprising four second HDD signal pins connected to the solid state storage unit, a plurality of second power pins connected to the second power circuit, a plurality of second ground pins, and a plurality of second memory signal pins connected to the RAM unit;
wherein in response to the edge connector of the expansion card being engaged in the expansion slot of the motherboard, the protrusion is engaged in the notch, the first HDD signal pins of the expansion slot are connected to the second HDD signal pins of the storage device, the plurality of first power pins of the expansion slot is connected to the plurality of second power pins of the storage device, the plurality of first ground pins of the expansion slot is connected to the plurality of second ground pins of the storage device, and the plurality of first memory signal pins of the expansion slot is connected to the second plurality of memory signal pins of the storage device.

10. The motherboard assembly of claim 9, wherein the first HDD signal pins of the expansion slot comprises a pair of signal input pins and a pair of signal output pins, the second HDD signal pins of the storage device comprises a pair of signal input pins and a pair of signal output pins.

11. The motherboard assembly of claim 7, wherein the expansion slot is a memory slot.
